(19) United States
(12) Patent Application Publication
(10) Pub. No.: US 2023/0039709 A1
(43) Pub. Date: Feb. 9, 2023

(54) MULTI-SPEED VIBRATOR FOR PHALLIC DEVICES

(71) Applicant: Martin Tucker, Tarzana, CA (US)

(72) Inventor: Martin Tucker, Tarzana, CA (US)

(21) Appl. No.: 17/880,627

(22) Filed: Aug. 3, 2022

Related U.S. Application Data
(60) Provisional application No. 63/228,736, filed on Aug. 3, 2021.

(51) Int. Cl. A61H 19/00; A61H 23/02

(52) U.S. Cl. CPC A61H 19/44; A61H 23/0254; A61H 2201/1695; A61H 2201/5097

(57) ABSTRACT

A sexual stimulation apparatus comprising a vibrator mechanism, a body, wherein the body includes a phallic arm, and a base enclosing the vibrator mechanism, wherein the base includes an attachment mechanism, wherein the phallic arm comprises ribs and an enlarged distal section, and wherein the attachment mechanism comprises a threaded female receiver to allow for the attachment of male threaded attachments. The sexual stimulation apparatus further comprising a controller, a power source, and a means for control, wherein the means for control communicates with the motor of the vibrator mechanism, wherein the power source provides power to the motor, and wherein the means for control allows the user to control the vibrator mechanism.

### CROSS-REFERENCE TO RELATED APPLICATION

This application claims the benefit of U.S. Provisional Patent Application Ser. No. 63/228,736 filed Aug. 3, 2021, titled “MULTI-SPEED VIBRATOR AND ADJUSTABLE MOUNT FOR PHALLIC DEVICES,” and the subject matter thereof is incorporated herein by reference thereto.

### TECHNICAL FIELD

The present invention relates to a sexual stimulation device, and more specifically to a multi-speed vibrator for phallic devices.

### BACKGROUND ART

Sex toys and erotic sexual stimulation devices are abundant in the prior art. Many sexual stimulation devices provide thrusting of a dildo or other phallic device, while some simply provide a placement point for a phallic device and the user moves either themselves or the phallic device as desired. These prior art devices require the phallic device to be attached to a device via a connection point. When the devices provide thrusting, they only provide certain movement of the phallic device, typically only movement that is parallel to the thrusting device. There are currently no devices on the market that provide a phallic device that can be attached to a sex machine that provides multi-speed vibration.

Therefore, there is a need for a vibrating phallic device attachment that can be used with prior art thrusting machines, is lightweight, can be used without a thrusting machine, and securely holds a phallic device. The prior art invention overcomes the shortcoming contained in the prior art by providing a such a device that provides all of those features.

Certain embodiments of the invention have other steps or elements in addition to or in place of those mentioned above. The steps or element will become apparent to those skilled in the art from a reading of the following detailed description when taken with reference to the accompanying figures.

None of the prior art fully addresses the problems resolved by the present invention. The present invention overcomes these limitations contained in the prior art by providing a multi-speed vibrator for phallic devices that is sturdy, reliable, easy to use, safe, inexpensive, and provide vibration.

### BRIEF DESCRIPTION OF THE DRAWINGS

FIG. 1 illustrates a perspective view of the multi-speed vibrator apparatus of the present invention;

FIG. 2 illustrates a perspective view of the multi-speed vibrator apparatus of the present invention when disassembled;

FIG. 3 illustrates a side view of the multi-speed vibrator apparatus of the present invention inserted in a phallic sleeve and disposed on a thrusting arm; and

FIG. 4 illustrates a side cut-away view of the phallic sleeve of the present invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures. The term “on” means that there is direct contact among elements.

The present invention provides a sexual stimulation device that comprises a multi-speed vibrator for phallic devices.

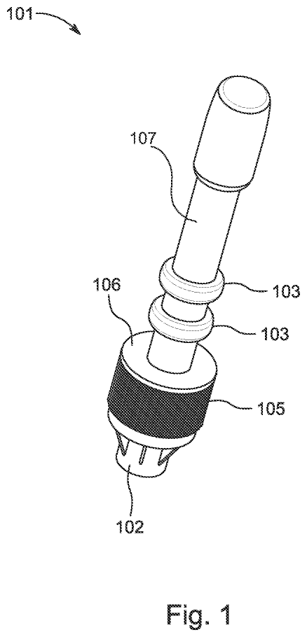

FIG. 1 shows a perspective view of the multi-speed vibrator apparatus 101 of the present invention. Multi-speed vibrator apparatus 101 comprises body 106, base 105, and phallic arm 107. Body 106 is attached to base 105. Ribs 103 are disposed on phallic arm 107 and act to securably attach a phallic sleeve and hold the phallic sleeve in place on phallic arm 107. Connection point 102 allows multi-speed vibrator apparatus 101 to be attached to other devices. Phallic arm 107 is disposed on body 106. Body 106 and base 105 are removably attached.

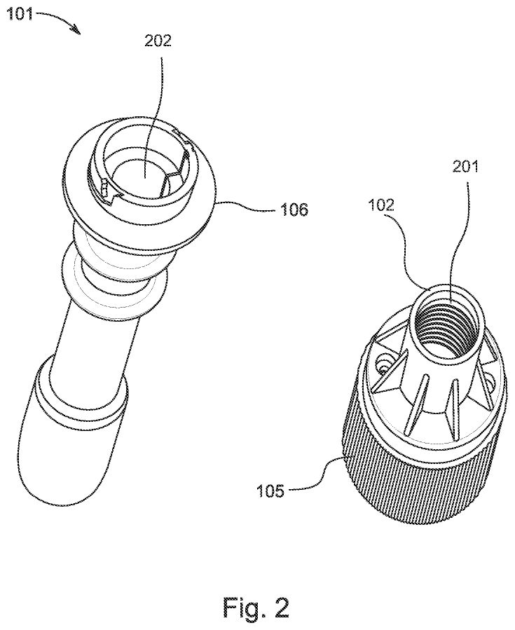

FIG. 2 shows a perspective view of the multi-speed vibrator apparatus 101 when disassembled. Body 106 attaches to base 105 via any desired locking mechanism that connects the two pieces together securably easily and removably. Batteries, or other power source, are contained in opening 202. Base 105 comprises a vibrating motor and completes the circuit with the batteries located in opening 202 when body 106 is attached to base 105. Connection point 102 comprises receiving threads 201. Receiving threads 201 allow multi-speed vibrator apparatus 101 to be attached to any number of apparatuses.

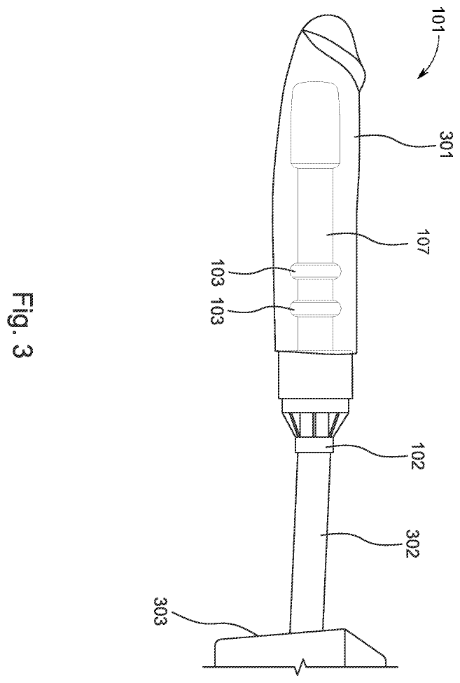

FIG. 3 shows a side view of the multi-speed vibrator apparatus 101 of the present invention inserted in a phallic sleeve 301. Ribs 103 act to secure phallic sleeve 301 to phallic arm 107 of the multi-speed vibrator apparatus 101. Connection point 102 is attached to thrusting arm 302 that is disposed on thrusting device 303.

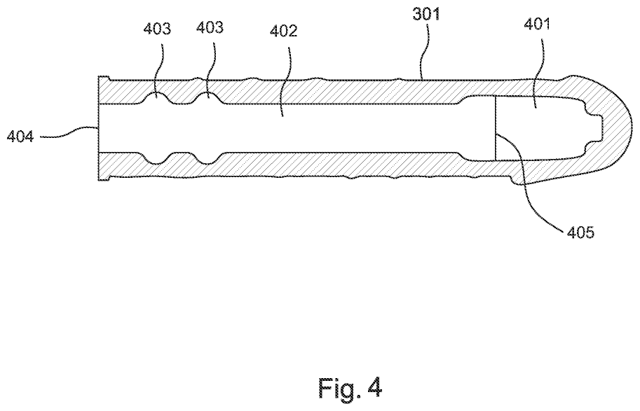

FIG. 4 illustrates a side cut-away view of the phallic sleeve 301 of the present invention. Sleeve opening 404 allows for the insertion of phallic arm 107 (not show in this drawing). Phallic arm 107 fits snuggly in sleeve tunnel 402. Sleeve tunnel 402 terminates at sleeve inner wall 405. The area between sleeve inner wall 405 and the distal end of phallic sleeve 301 creates sleeve solid end 401. Phallic sleeve ribs 403 act to securely hold phallic arm 107 in place. The design of sleeve tunnel 402 and the design of phallic arm 107 act together to securably hold the phallic sleeve 301 in place, while also allowing the phallic sleeve 301 to be removed by the user when desired, without any additional tools or powders.

The vibration of the multi-speed vibrator apparatus 101 is controlled by the user via manual controls contained on the device, wireless communication, or other appropriate means.

Connection point 102 comprises an attachment point receiver that can easily be attached to any connection point, including, but not limited to, prior art thrusting devices, stationary devices such as suction cups, etc. The connection can be any type of connection as desired.

Phallic sleeve 301 is hollow, enclosed rubber (or other appropriate material) and phallic shaped. Phallic sleeve 301 fits snugly on phallic arm 107. Ribs 103 phallic sleeve ribs 403 act together to create suction in order to hold phallic sleeve 301 in place securely and prevent phallic sleeve 301 from sliding off of phallic arm 107. Sleeve tunnel 402 of the phallic sleeve 301 is of such a shape that it fits securely around phallic arm 107.

Although a phallic device has been shown, any type of sexual toy that fits multi-speed vibrator apparatus 101 can be attached and used with the current invention.

In one embodiment of the present invention, multi-speed vibrator apparatus 101 of the present invention is rechargeable.

In one embodiment of the present invention, phallic arm 107 can be removed from body 106. In this embodiment, a connection point is disposed on body 106 that allows for other devices to be attachbly disposed on multi-speed vibrator apparatus 101.

Multi-speed vibrator apparatus 101 provides any type and direction of vibration, in any number of patterns, as chosen by the user. The vibrations can be in the lateral direction, with reference to the phallic arm 107, as well as in any other direction with respect to the phallic arm 107.

Any number of devices can be disposed on phallic arm 107.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A sexual stimulation apparatus comprising:
a vibrator mechanism;
a body, wherein the body includes a phallic arm; and
a base enclosing the vibrator mechanism, wherein the base includes an attachment mechanism;
wherein the phallic arm comprises ribs and an enlarged distal section; and
wherein the attachment mechanism comprises a threaded female receiver to allow for the attachment of male threaded attachments.

2. The device of claim 1, further comprising:
a controller;
a power source; and
a means for control, wherein the means for control communicates with the motor of the vibrator mechanism;
wherein the power source provides power to the motor; and
wherein the means for control allows the user to control the vibrator mechanism.

3. The device of claim 1, wherein the body and base are removably attached.

4. The device of claim 1, wherein a phallic sleeve is disposed on the phallic arm.

5. The device of claim 4, wherein the phallic sleeve comprises an opening, phallic sleeve ribs, and sleeve solid end.

6. The device of claim 1, further comprising a battery disposed within the body to provide power to the motor.

7. The device of claim 1, wherein the apparatus is operated wirelessly or using other control device/option.

8. A sexual stimulation apparatus comprising:
a vibrator mechanism;
a body, wherein the body includes a phallic arm;
a base enclosing the vibrator mechanism;
an attachment mechanism; and
an attachment;
wherein the phallic arm comprises ribs and an enlarged distal section;
wherein the attachment mechanism comprises a threaded female receiver; and
wherein the attachment comprises a threaded male receiver.

9. The device of claim 8, wherein the threaded male receiver is inserted into the threaded female receiver.

10. The device of claim 8, wherein the threaded male receiver is disposed on a plate, wherein the plate comprises connection points.

11. A sexual stimulation apparatus comprising:
a vibrator mechanism;
a body, wherein the body includes a connection point;
a base enclosing the vibrator mechanism; and
an attachment mechanism;
wherein a sexual device is disposed on the connection point; and
wherein the attachment mechanism comprises a threaded female receiver to allow for the attachment of male threaded attachments.
